(19) United States
(12) Patent Application Publication
(10) Pub. No.: US 2006/0178203 A1
(43) Pub. Date: Aug. 10, 2006

(54) Wagering game network having a progressive lottery gaming event

(76) Inventors: Darryl Hughes, River Forest, IL (US); Joel R. Jaffe, Glenview, IL (US); Jason Smith, Arlington Heights, IL (US); William R. Wadleigh, Lisle, IL (US); Gene Rigsby, Chicago, IL (US)

Correspondence Address: Daniel J. Burnham;JENKENS & GILCHRIST, A PROFESSIONAL CORPORATION, 225 W. Washington, Ste. 2600, Chicago, IL, 60606-3418, US

(21) Appl. No.: 11/294,098

(22) Filed: Dec. 5, 2005

Related U.S. Application Data
(60) Provisional application No. 60/633,502, filed on Dec. 6, 2004.

(51) Int. Cl. A63F 13/00

(52) U.S. Cl. 463/20; 463/27

(57) ABSTRACT

A method and gaming network for conducting a progressive gaming event is disclosed. The method includes receiving a wager from a player to play a basic wagering game and displaying the basic wagering game on a video display. The progressive gaming event is initiated and a plurality of players, playing the basic wagering game, are selected to participate in the progressive gaming event. A plurality of player-selectable objects are displayed on the video display from which the plurality of players may select. A simulated drawing is presented to the plurality of selected players. The simulated drawing displays a combination of randomly generated winning objects to the plurality of players on a communal display.

### CROSS REFERENCE TO RELATED APPLICATIONS

This application claims the benefit of priority of U.S. Provisional Patent Application No. 60/633,502, filed Dec. 6, 2004, which is hereby incorporated by reference in its entirety.

### FIELD OF THE INVENTION

The present invention relates generally to wagering games and, more particularly, to a wagering game network having a progressive lottery gaming event feature.

### BACKGROUND OF THE INVENTION

Gaming terminals, such as slot machines, video poker machines and the like, have been a cornerstone of the gaming industry for many years. Generally, the popularity of such machines with players is dependent on the likelihood (or perceived likelihood) of winning money at the gaming terminal and the intrinsic entertainment value of the machine relative to other available gaming options. Where the available gaming options include a number of competing machines and the expectation of winning on each machine is roughly the same (or believed to be the same), players are most likely to be attracted to the most entertaining and exciting machines. Shrewd operators constantly strive to employ the most entertaining and exciting machines available, because such machines attract frequent play and hence increase profitability to the operator.

One concept that has been successfully employed to enhance the entertainment value of a game is that of a “secondary” or “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves the collecting of coin-in data from participating gaming device(s) (e.g., slot machines), contributing a percentage of that coin-in data to a jackpot amount, and awarding that jackpot amount to a player upon the occurrence of a certain jackpot-won event. A jackpot-won event typically occurs when a “progressive winning position” is achieved at a participating gaming device. If the gaming device is a slot machine, a progressive winning position may, for example, correspond to alignment of progressive jackpot reel symbols along a certain pay line. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement. Typically, the jackpot is awarded when a player achieves a predetermined “jackpot” outcome at their gaming machine.

While these player appeal features provide some enhanced excitement relative to other known games, there is a continuing need to develop new features for gaming machines to satisfy the demands of players and operators. Specifically, the current progressive games only provide enhanced excitement to the player achieving the jackpot. Thus, there is a need for engaging multiple players within a single progressive game.

### SUMMARY OF THE INVENTION

According to one embodiment of the present invention, a method for conducting a progressive gaming event is disclosed. The method comprises receiving a wager from a player to play a basic wagering game and displaying the basic wagering game on a video display. The method further comprises initiating the progressive gaming event and selecting a plurality of players, playing the basic wagering game, to participate in the progressive gaming event. The method further comprises displaying a plurality of player-selectable objects on the video display from which the plurality of players may select. The method further comprises presenting a simulated drawing to the plurality of selected players. The simulated drawing displays a combination of winning objects to the plurality of players on a communal display. The plurality of winning objects are randomly generated.

According to another embodiment of the present invention, a progressive gaming network for conducting a progressive game is disclosed. The progressive gaming network comprises a plurality of gaming terminals, a communal display, and a wagering game control network. Each of the gaming terminals have a wager receptor for receiving a wager from a player to play a basic wagering game, and a display for displaying the basic wagering game. The communal display presents a simulated drawing to a plurality of players. The wagering game control network is in communication with the plurality of gaming terminals. The wagering game control network has (i) a network memory capable of storing a progressive award value, and (ii) a controller coupled to the network memory. The controller is operative to (a) initiate the progressive game, (b) randomly generate a plurality of numbers, (c) display the simulated drawing on the communal display such that the simulated drawing presents the randomly generated plurality of numbers to the plurality of players, and (d) determine whether the progressive award has been achieved.

According to yet another embodiment of the present invention, a method of conducting a lottery gaming event is disclosed. The method comprises initiating the lottery gaming event on a gaming network when the lottery gaming event has been triggered. The method further comprises selecting a plurality of players on the gaming network to participate in the lottery gaming event. The plurality of players are located at a plurality of gaming terminals within the gaming network. The method further comprises displaying a plurality of user-selectable numbered objects on a video display on the gaming terminal of each of the selected plurality of players. Each of the plurality of players is capable of selecting a plurality of objects from the user-selectable numbered objects. The method further comprises presenting a simulated drawing to the plurality of selected players. The simulated drawing displays a combination of winning numbered objects to the plurality of players on a communal display included with the gaming network. The plurality of winning numbered objects are randomly generated by the gaming network.

According to one embodiment of the present invention, a method of conducting a wagering game is disclosed. The method comprises the acts of receiving a wager from a player to play a basic wagering game and displaying the basic wagering game on a video display. The method further comprises the acts of providing a progressive gaming event accompanying the basic wagering game and initiating the progressive gaming event when the progressive gaming event has been triggered by the basic wagering game. The method further comprises the act of selecting a plurality of players, playing the basic wagering game, to participate in the progressive gaming event. The plurality of players include the player that triggered the progressive gaming event within the basic wagering game. The method further comprises the acts of displaying a plurality of player-selectable objects on the video display for each of the plurality of players to select from and selecting a plurality of objects from the plurality of player-selectable objects. The method further comprises the act of presenting a simulated drawing to the plurality of selected players. The simulated drawing displaying a combination of winning objects to the plurality of players on a communal display. The plurality of winning objects are electronically generated. The method further comprises the acts of determining the number of matching objects by comparing the selected plurality of objects to the combination of winning objects, and presenting an award to one or more of the plurality of players when the number of matching objects meets a predetermine criterion.

According to another embodiment of the present invention, a progressive gaming network is disclosed. The progressive gaming network comprises a plurality of linked gaming terminals and at least one communal display. Each gaming terminal allows a player to play a basic wagering game. By playing the basic wagering game, the player is allowed to be eligible for a progressive game. In response to the progressive game being triggered, each of the players at the plurality of gaming terminals selects a group of objects from a plurality of objects. The least one communal display is in proximity to the plurality of gaming terminals. The communal display displays the randomly selected winning group of objects from the plurality of objects. A player is awarded one or more jackpot in the progressive game based on the amount of matching objects between the randomly selected winning group of objects and the group of objects selected by the player.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

FIG. 1 is a perspective view of a gaming terminal according to one embodiment of the present invention.

FIG. 2 illustrates a control system that is used in conjunction with the gaming terminal of FIG. 1.

FIG. 3 is an image of a game screen of a wagering game that is displayed on the gaming terminal of FIG. 1, according to one embodiment of the present invention.

FIG. 4 is an architectural view of a gaming network having a plurality of the gaming terminals of FIG. 1, according to one embodiment of the present invention.

FIG. 5 is a flowchart illustrating a LOTTO BONUS gaming event, according to one embodiment of the present invention.

FIG. 6 is an image of a number selection screen that is displayed on the gaming terminal of FIG. 1, according to one embodiment of the present invention.

FIG. 7 is an illustration of a simulated drawing presented on a communal display of the gaming network of FIG. 4, according to one embodiment of the present invention.

FIG. 8 is an image of the number selection screen of FIG. 6 after a plurality of numbers have been selected and drawn.

FIG. 9 illustrates a LOTTO BONUS gaming event being conducted on a communal display of the gaming network of FIG. 4, according to another embodiment of the present invention.

FIG. 10 illustrates the conclusion of the LOTTO BONUS gaming event of FIG. 9 being conducted on the communal display.

FIG. 11 illustrates a control system that is used in conjunction with the gaming terminal of FIG. 1 to provide the LOTTO BONUS gaming event, according to another embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

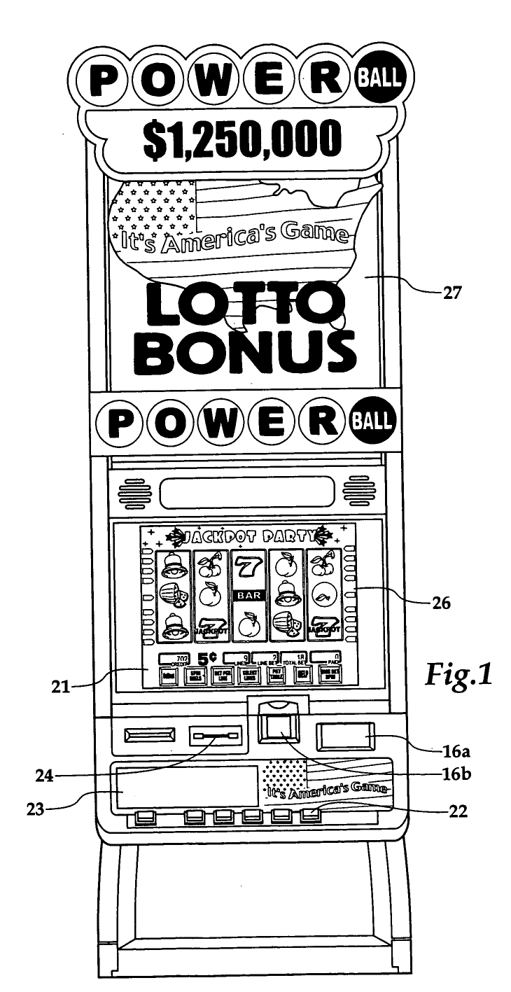

Turning now to the drawings, FIG. 1 is a perspective view of a gaming terminal 10 according to one embodiment of the present invention. The gaming machine 10 is operable to conduct a wagering game. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video casino games, such as blackjack, slots, keno, poker, etc.

The gaming terminal 10 includes input devices, such as a wager acceptor 16, a touch screen 21, a push-button panel 22, and an information reader 24. For outputs, the gaming terminal 10 includes a payout mechanism 23, a main display 26 for displaying information about a basic wagering game such as video poker and a secondary display 27 for displaying additional information, and an output receptacle 28 coupled to the payout mechanism 23 for providing tokens or coins to the player when the player selects to cash out. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The wager acceptor 16 may include one or both of a coin slot acceptor or a currency note acceptor to input value to the gaming terminal 10. Additionally, the wager acceptor 16 may include a card-reading device for reading a card that has a recorded monetary value with which it is associated. The card may also authorize access to a central account, which can transfer money to the gaming terminal 10.

The payout mechanism 23 performs the reverse functions of the wager acceptor 16. For example, the payout mechanism 23 may include a coin dispenser or a note dispenser to output value from gaming terminal 10. Also, the payout mechanism 23 may be adapted to receive a card that authorizes the gaming terminal to transfer credits from the gaming terminal 10 to a central account.

The push button panel 22 is typically offered, in addition to the touch screen 21, to provide players with an option of how to make their game selections. Alternatively, the push button panel 22 provides inputs for one aspect of operating the game, while the touch screen 21 allows for inputs needed for another aspect of operating the game.

The operation of the basic wagering game is displayed to the player on the main display 26. The main display 26 and the secondary display 27 may take the form of a cathode ray tube (CRT), a high resolution LCD, a plasma display, LED, or any other type of video display suitable for use in the gaming terminal 10. As shown, the main display 26 includes a touch screen 21 overlaying the entire monitor (or a portion thereof) to allow players to make game-related selections. Similarly, a touch screen may overlay the secondary display 27. Alternatively, the gaming terminal 10 may have a number of mechanical reels to display the game outcome, as well.

The information reader 24 allows for the identification of a player by reading information, for example, a player's card, indicating the player's true identity. Currently, the identification is used by casinos for rewarding certain players with complimentary services or special offers. For example, a player may be enrolled in the gaming establishment's players' club and may be awarded certain complimentary services as that player collects points in the player's player-tracking account. The player inserts the player's card into the player-identification card reader 24, which allows the casino's computers to register that player's wagering at the gaming terminal 10.

The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

In some embodiments, the information reader 24 may include a biometric reader, such as a finger, hand, or retina scanner, and the unique identifier may be the scanned biometric information. Additional information regarding biometric scanning, such as fingerprint scanning or hand geometry scanning, is available from International Biometric Group LLC of New York, N.Y. Other biometric identification techniques can be used as well for providing a unique identifier of the player. For example, a microphone can be used in a biometric identification device on the gaming terminal so that the player can be recognized using a voice recognition system.

In some embodiments, the gaming terminal 10 includes a radio frequency identification device (RFID) transceiver or receiver so that an RFID transponder held by the player can be used to provide the unique identifier of the player at the gaming terminal 10 without the need to insert a card into the gaming terminal 10. Examples of RFID components that can be used with the present intention are available from Pacific Northwest National Laboratory (under the United States Department of Energy) of Richland, Wash.

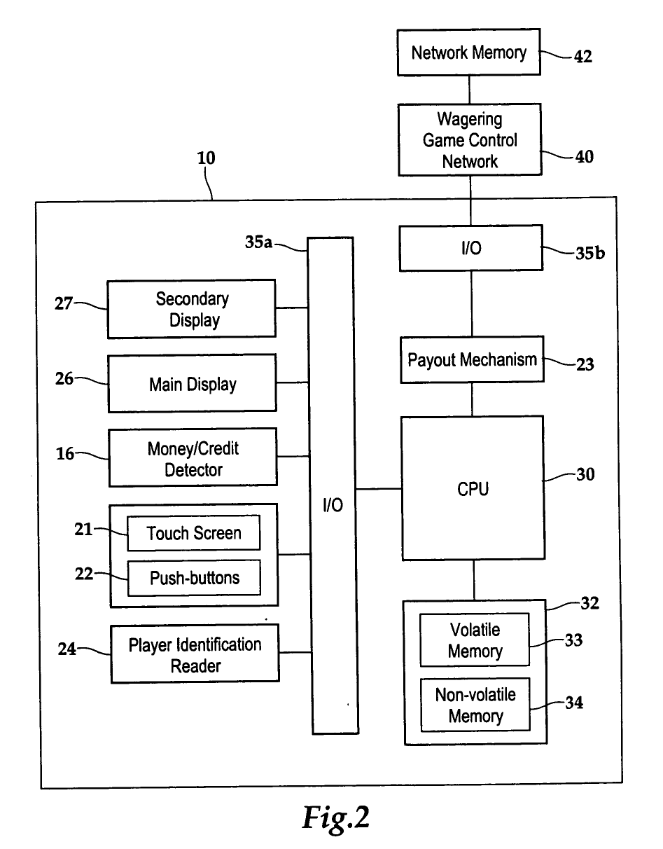

Referring also to FIG. 2, the various components of the gaming terminal 10 are controlled by a central processing unit (CPU) 30 (such as a microprocessor or microcontroller). To provide the gaming functions, the CPU 30 executes a game program. The CPU 30 is also communicatively coupled to or includes a local memory 32. The local memory 32 may comprise a volatile memory 33 (e.g., a random-access memory, “RAM”) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

The gaming terminal 10 is typically operated as part of a game control network 40 having control circuitry and memory devices, wherein a plurality of gaming terminals are coupled to the game control network 40. The game control network 40 can be the game controller that controls operation of the wagering game as described below. The game control network 40 may optionally include a network memory 42 for alternative storage of data. The network memory 42 may be used, for example, in persistent state gaming, where a feature or asset of the player's game may be saved for future use when the player returned for a later gaming session at a different gaming terminal that is also connected to the network 40. The network memory 42 can include instructions for playing games, such as, progressive jackpots that are contributed to by all or some of the gaming terminals 10 in the network 40.

The processor, memory, or both may be remotely located on the game control network 40. For example, instead of the CPU 30, the game control network 40 may determine the random outcomes for games conducted on the gaming terminal(s) 10. Alternatively, the CPU 30 randomly determines the game outcomes.

The gaming terminal 10 often has multiple serial ports, each port dedicated to providing data to a specific host computer system that performs a specific function (e.g., accounting system, player-tracking system, etc.). To set up a typical serial communication hardware link to the host system, the typical RS-232 point-to-point communication protocol that is often present in the gaming terminal 10 is converted to an RS-485 (or RS-485-type) master-slave protocol so as to take advantage of some of the benefits of the RS-485 capability (e.g., multi-drop capability that allows many gaming terminals 10 to communicate with the game control network 40). To perform this function, a custom interface board may be used by the gaming terminal 10 for each communication port in the gaming terminal 10. It should be noted that the gaming terminal 10 can initially be designed to be configured for a typical RS-485 protocol, instead of the typical RS-232 protocol. Further, the gaming terminal 10 may simply be designed for an Ethernet connection to the game control network 40.

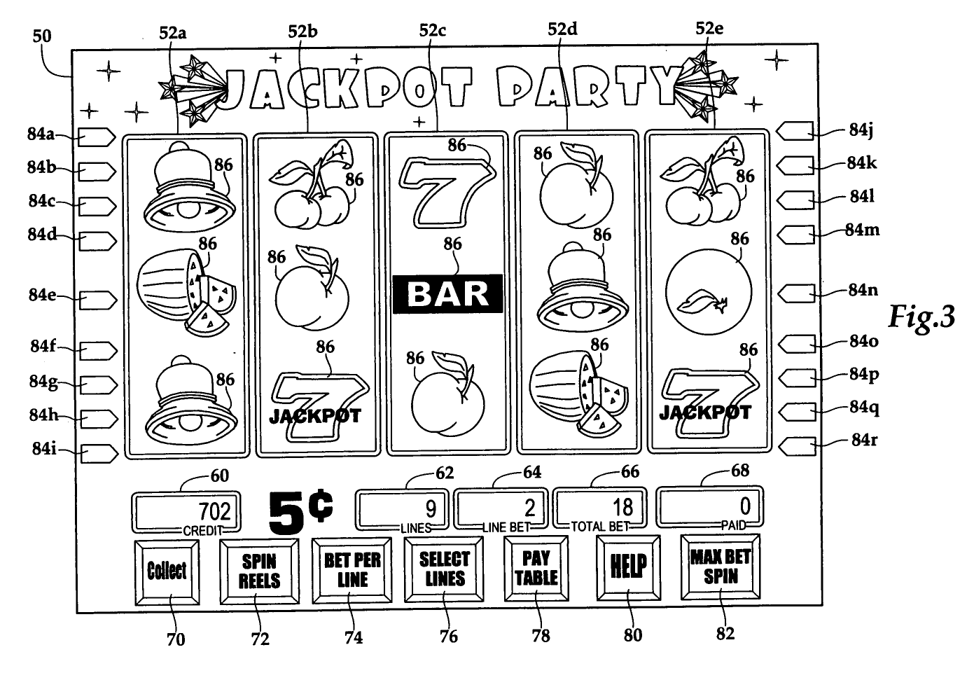

Referring now to FIG. 3, an image of a main game screen 50 is illustrated, according to one embodiment of the present invention. A player begins play of a basic wagering game by inserting a wager into the wager input accepter 16 of the gaming terminal 10. A player can select play by either using the touch screen 21 or push-button panel 22. The CPU 30, or the wagering game control network 40 in alternative embodiments, operates to execute a wagering game program causing the main video display 26 to display the wagering game that includes a plurality of visual elements.

The basic game screen 50 may be displayed on the main video display 26 or on a portion thereof. In the illustrated embodiment, the basic game screen 50 is used to display a plurality of simulated, movable reels 52a-e with symbols displayed thereon. However, the basic game screen 50 may have a plurality of mechanical reels in other embodiments. The reels 52a-e are positioned such that the symbols 86 are displayed relative to at least one payline 84, yielding a plurality of outcomes for the basic game. The basic game screen 50 may also display a plurality of game session meters and various buttons selectable by a player. The game session meters include a “credit” meter 60 for displaying a number of credits available for play on the machine; a “lines” meter 62 for displaying a number of paylines to be played by a player on the machine; a “line bet” meter 64 for displaying a number of credits wagered (e.g., from 1 to 5 credits) for each of the number of paylines played; a “total bet” meter 66 for displaying a total number of credits wagered for the particular round of wagering; and a “paid” meter 68 for displaying an amount to be awarded based on the results of the particular rounds wager. The user-selectable buttons include a “collect” button 70 to collect the credits remaining in the credits meter 60; a “help” button 72 for viewing instructions on how to play the wagering game; a “pay table” button 74 for viewing a pay table associated with the basic wagering game; a “select lines” button 76 for changing the number of paylines (displayed in the lines meter 62) a player wishes to play; a “bet per line” button 78 for changing the amount of the wager which is displayed in the line bet meter 64; a “spin reels” button 80 for moving the reels 52a-e; and a “max bet spin” button 82 for wagering a maximum number of credits and moving the reels 52a-e of the basic wagering game. While the gaming terminal 10 allows for these types of player inputs, the present invention does not require them and can be used on gaming terminals having more, less, or different player inputs.

In FIG. 3, the five depicted reels 52a-e have a plurality of symbols 86 displayed thereon and at least one activated payline 84 extending from one of the payline indicators 84a-i on the left side of the screen 50 to any one of the payline indicators 84j-r on the right side of the screen 50. The plurality of symbols 86 displayed on the plurality of reels 52a-e are used to indicate a plurality of possible outcomes along each of the activated paylines 84. The symbols 86 may include a “LOTTERY” symbol, a “POWERBALL” symbol, a “TICKET” symbol, or other similar themed symbols. POWERBALL® and POWERBALL, IT'S AMERICA'S GAME™ are trademarks of the Multi-State Lottery Association, West Des Moines, Iowa. As used herein, the term powerball shall refer to a specialized lottery ball used as a numbered secondary object.

Standard gaming symbols such as “1-BAR” symbols, “2-BAR” symbols, “3-BAR” symbols, “CHERRY” symbols, “SEVEN” symbols, and “BELL” symbols may be depicted on the reels 52a-e in some embodiments. In some embodiments, the symbols 86 may represent a particular game theme and may be selected from images corresponding to the particular theme. Further explanation of the composition of the symbols 86 and/or their potential themes is not required to understand the present invention.

A winning combination occurs when the symbols 86 appearing on the reels 52a-e correspond to one of the winning symbol combinations listed in a pay table stored in the memory 32 of the gaming terminal 10. The pay table may be displayed on the secondary display 27, the main display 26, or both and be either displayed constantly, intermittently, or upon request by a player (e.g., by selecting the pay-table button 74). Such winning combinations are displayed relative to one or more payline 84. The activated paylines 84 extend between activated pairs of payline indicators 84a-r such as, for example, the payline that extends between payline indicators 84e and 84n. Winning combinations listed in the pay table can include three like-symbols appearing on a payline yielding a first payout, four like-symbols appearing on a payline yielding a second, larger payout, and five like-symbols appearing on a payline yielding a third, even larger payout.

The reels 52a-e may be either traditional mechanical reels or they may be computer-generated images of reels. The payline indicators 84a-r indicate a randomly selected outcome for each payline 84, which is the combination of symbols 86 on the reels 52a-e along the particular payline 84. A player may play multiple paylines 84 by selecting the select-lines button 76 until the desired number of paylines 84 (up to nine in the illustrated embodiment) are displayed. While an embodiment with nine paylines is shown, a gaming terminal 10 with a single payline, or any plurality of paylines will also work with the present invention. Additionally, though an embodiment with five reels is shown, a gaming terminal 10 with any plurality of reels may also be used in accordance with the present invention.

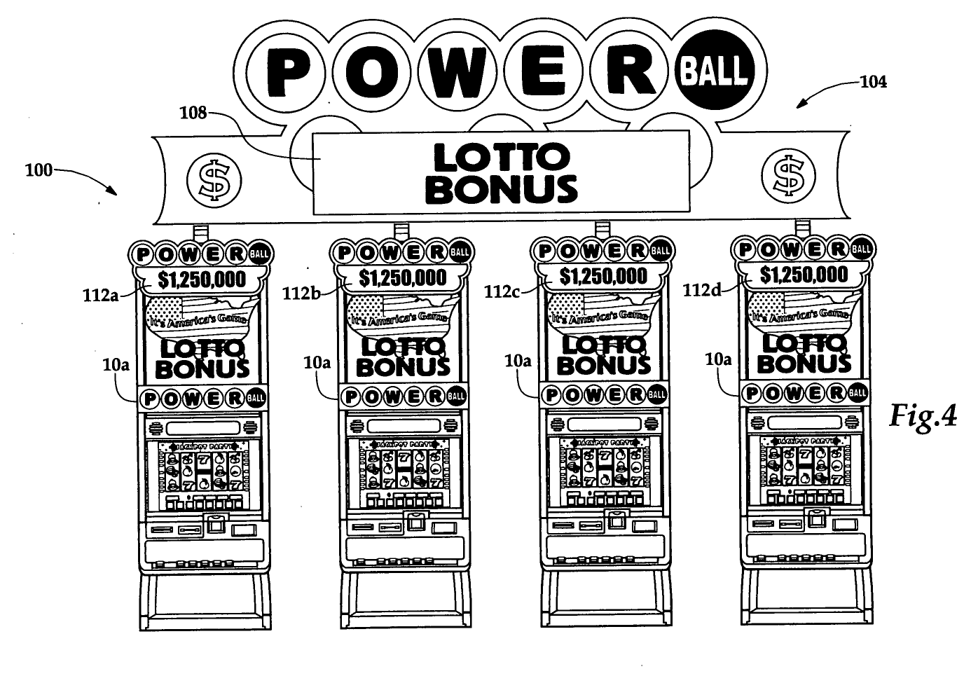

The basic wagering game described in FIG. 3 may include a bonus game as is generally known in the art. Additionally, or alternatively, the basic wagering game may include a progressive gaming event. The gaming terminal 10 described in FIGS. 1-2 can be connected to a progressive gaming network 100 (FIG. 4) to which a plurality of gaming terminals 10 are linked. The progressive gaming network 100 and, in particular, a “LOTTO BONUS” gaming event will be described below with reference to FIGS. 4-8.

FIG. 4 is an architectural view of a progressive gaming network 100 capable of providing a LOTTO BONUS gaming event. The gaming network 100 includes a plurality of gaming terminals 10a-d. The gaming terminals 10a-d are of the type described above with respect to FIGS. 1-2. The gaming network 100 includes signage 104, which may be, for example, located above the gaming terminals 10a-d. The signage 104 includes a communal display 108 for displaying the progressive game or a portion thereof, which in this embodiment is the LOTTO BONUS gaming event. The gaming terminals 10a-d may each contain a jackpot display 112a-d displaying the award amount for the progressive game. Alternatively, the signage 104 may contain one or more jackpot displays. In some embodiments of the present invention, the progressive game is a multi-level progressive game and the jackpot displays may be used to display a plurality of award levels.

The signage 104 and the gaming terminals 10a-d are coupled to the wagering game control network 40 (FIG. 2). The game control network 40 transmits information to and receives information from the CPU 30 in each of the gaming terminals 10a-d. Thus, all of the gaming terminals 10a-d are linked to the progressive game. Alternatively, the processor within terminal 10a may be in communication with external processors such as those within each of the gaming terminals 10b-d. In these embodiments, the combination of the processors within the gaming network 100 control the signage 104, communal display 108, the progressive gaming event, and determine the award amount for the progressive game. For example, the processors within the gaming network 100 can determine the progressive award amount by combining the individual progressive award contributions (that may be contained in the local memory 32 of each terminal 10a-d) for each terminal 10a-d.

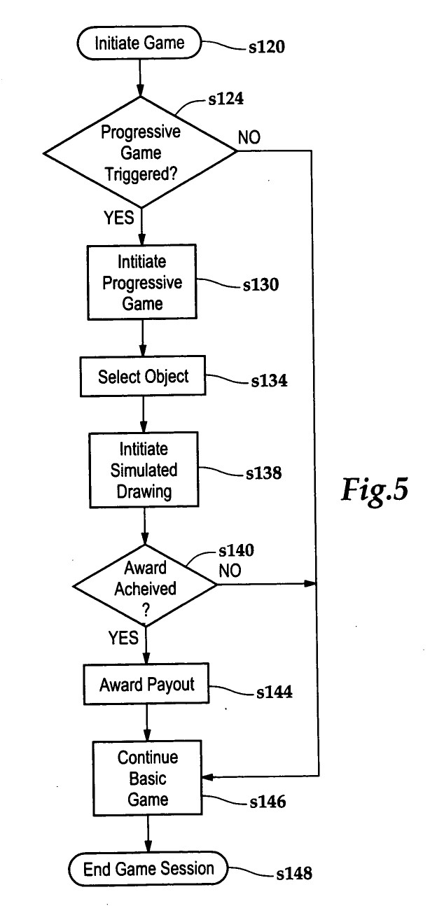

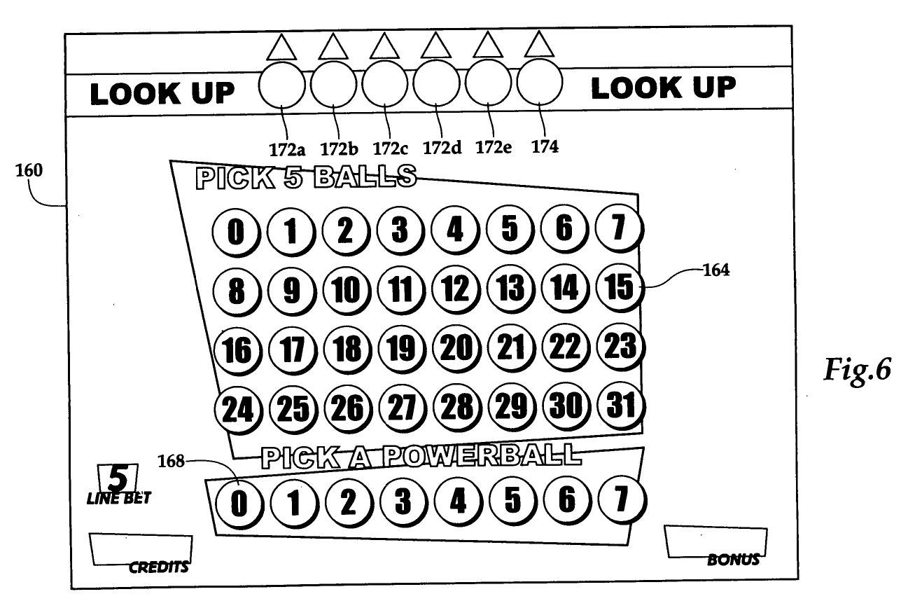

Turning now to FIG. 5, the operation of the LOTTO BONUS gaming event of the gaming network 100 will be described, according to one embodiment. Reference to FIGS. 6-8 will be made to best describe this operation. In step s120, a player at the gaming terminal 10 begins a gaming session by any conventional method (e.g., inserting coins or using credits). Each gaming terminal 10a-d has a basic wagering game operable thereon. In the illustrated example, the basic wagering game is a slot game that involves a player choosing a number of paylines 84 to play and choosing a wager to place on each payline 84.

At step s124, it is determined if the progressive game has been triggered. The progressive game may be randomly triggered, may be triggered by the occurrence of a particular event (e.g., a particular combination of symbols 86 appear on the reels 52a-e, etc.) or may be randomly triggered only after a particular threshold value for the progressive jackpot has been met. If the progressive game has not been triggered, then the basic game continues, at step s146, to its completion where the player is then prompted to begin another game-play cycle (e.g., another reel spin).

If, at step s124, a progressive game has been triggered, a plurality of players at the gaming terminals 10 are selected to participate in the LOTTO BONUS gaming event. Once a gaming terminal 10 has been selected to participate, the basic game may be interrupted and the LOTTO BONUS gaming event may begin, at step s130. Alternatively, the player may be allowed to complete the basic game before the LOTTO BONUS gaming event begins, at step s130.

Once the LOTTO BONUS gaming event has begun, a player is prompted to select a plurality of objects, at step s134. In some embodiments, the plurality of objects are numbers that may be, for example, located on a plurality of balls. FIG. 6 illustrates a number selection screen 160 having a plurality of user-selectable, standard, numbered balls 164 and a plurality of user-selectable, secondary balls 168, commonly referred to as powerballs. The number selection screen 160 also has a plurality of drawn-number indicators 172a-d and a drawn-secondary number indicator 174. According to some embodiments, a player is prompted to select five numbers from a pool of thirty-one numbered balls 160, and one secondary ball from a pool of seven numbered powerballs 168. The number selection screen 160 may be displayed on the main display 26, the secondary display 27, or both (FIG. 1).

According to some embodiments of the present invention, the player may be provided the option to select have the required number of objects randomly selected for them by selecting a “Quick Pick” button or other object. The selection of the Quick Pick button causes the gaming terminal 10 or the wagering game control network 40 to cause a plurality of objects to be randomly selected for the player. According to yet other embodiments, the player earns their numbers while playing the basic wagering game. For example, the reels 52a-e may include a plurality of numbered balls located thereon and when a numbered ball (or predetermined plurality of balls) appears on one or more of the activated paylines.

In still other embodiments, the group of players at the bank of terminals 10a-d earn numbers for the group as a whole, while playing the basic wagering game. These numbers are then the “Group Numbers” for the players at the bank of terminals 10a-d when the LOTTO BONUS gaming event is triggered. In this embodiment, when the LOTTO BONUS gaming event is triggered, the numbers earned by the players are displayed as the winning (selected) numbers for the group of players. Thus, each player at the bank of terminals 10a-d is hoping for the same combination of numbers to be selected, which may increase the overall excitement of the players and the camaraderie between players at the bank of terminals 10a-d. If the group numbers result in an award being awarded, the award is divided among each of the players. For example, the award may be awarded (i) evenly to each player, (ii) proportionally based on each players contributions to the group numbers, or (iii) as some combination of the above.

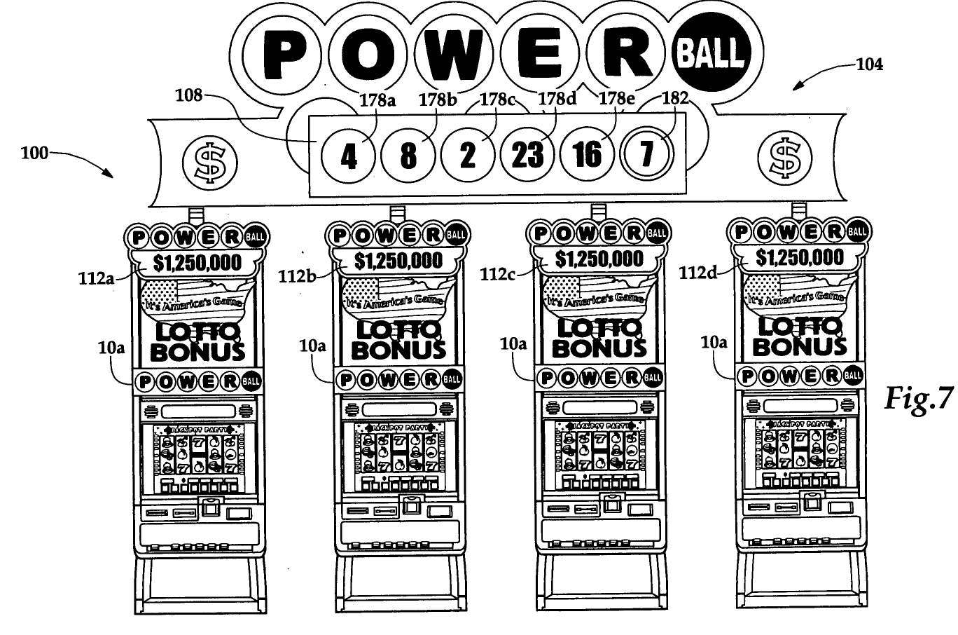

Once the participating players have selected the proper quantity of numbers, a simulated drawing is initiated, at step s138. The simulated drawing may be displayed on the communal display 108 and the player may be prompted on the number selection screen 160 to look at the communal display 108 once the drawing begins. The simulated drawing could additionally or alternatively be displayed on one of either the main display 26 or the secondary display 27 on each gaming terminal 10 (FIG. 1). In some embodiments, the simulated drawing is presented on the communal display 108 by displaying a plurality of drawn lottery balls 178a-e and a drawn powerball 182, as illustrated in FIG. 7.

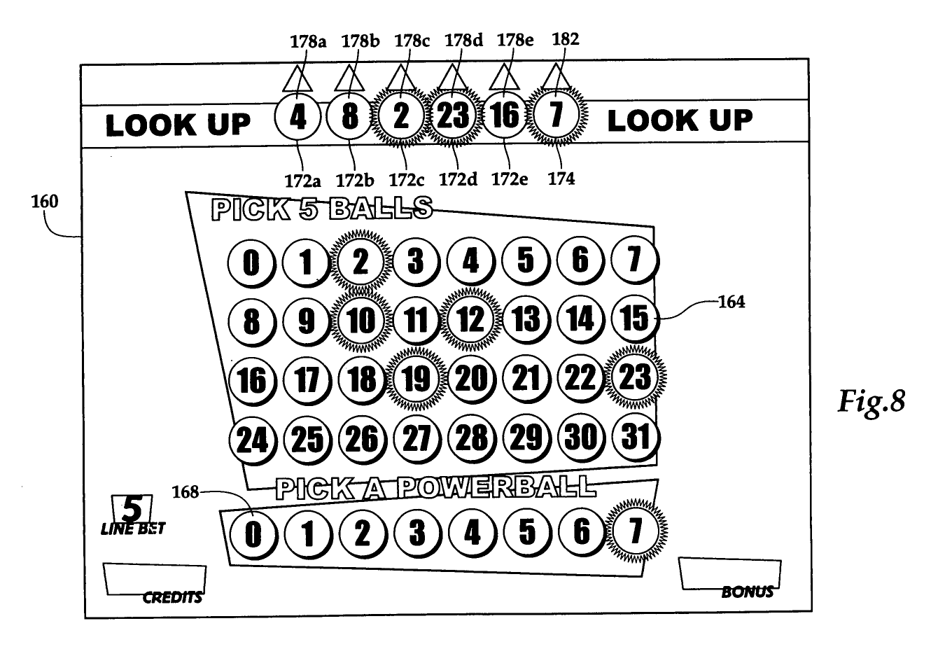

In some embodiments, the drawn balls are also presented to a player on the number selection screen 160, as illustrated in FIG. 8. The drawn balls 178a-e (FIG. 7) are displayed within the respective drawn-number indicators 172a-e. Additionally, the drawn powerball 182 is displayed within the drawn-secondary number indicator 174. An indicator may then be highlighted when a drawn ball or powerball matches a user-selected number. For example, in FIG. 8 a player has selected the numbers “2”, “10”, “12”, “19”, and “23” with a “7” for the secondary number. Thus, as illustrated in FIG. 8, the indicators 172c-d and 174 are highlighted because they match the numbers selected by the player.

At decision box s140, a determination is made as to whether one or more player participating in the LOTTO BONUS gaming event has achieved a bonus. An award may be achieved, for example, when a player's selected numbers match a predetermined amount of the drawn numbers. If an award has been achieved, at decision box s140, a payout is awarded at step s146. After a payout has been awarded, the players are returned to their basic game at step s146. If, however, an award has not been achieved, at decision box s140, a player is returned to their basic game, at step s146, without a payout being awarded. Once the basic game has completed, the gaming session ends, and a player is prompted to initiate a new game, at step s148.

As discussed above, at step s138, a simulated drawing is initiated and in some embodiments, the simulated drawing is presented on the communal display 108 by displaying a plurality of drawn balls. According to other embodiments, the simulated drawing is a simulation of an actual, real-life lottery drawing, complete with a host and hostess. The simulated drawing may be from a prerecorded, real-life, lottery drawing. Alternatively, the simulated drawing may be from a prerecorded, staged, lottery drawing.

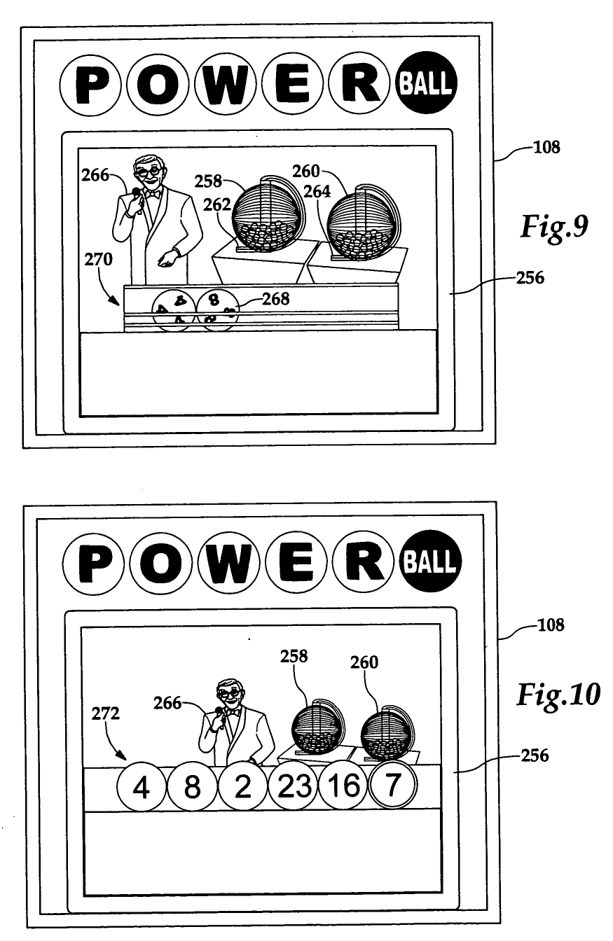

FIG. 9 illustrates a lottery drawing that may be initiated on the communal display 108, according to one embodiment of the present invention. As discussed, the lottery drawing can be presented as a real-life video 256. The real-life video 256 may show tumblers or drums 258 and 260 having a plurality of number-bearing balls bouncing around therein. One drum 258 contains the number-bearing balls for the lottery numbers while the other drum 260 contains the number-bearing powerballs. After a brief introduction (e.g., a drum roll, musical score, or the like), the real-life video 256 may show the five lottery balls being transferred one-by-one from the drum 258 into a chute 262 thereof. The drawing is concluded when the powerball is transferred to its chute 264. In some embodiments, a real-life host 266 may also be seen and/or heard on the video 256 announcing the numbers for each number-bearing ball. As each number-bearing ball 268 is announced, any number matching the player's selection may be automatically highlighted (e.g., by circling) on the player's number selection screen 160, thereby adding to the anticipation and excitement level of the gaming experience.

In some embodiments, the communal display 108, or alternatively the secondary display 27, may show a close-up view, indicated generally at 270, of one of the chutes 262 or 264 where the balls 268 can be seen rolling into the chutes with the numbers on the balls clearly discernable. The chute 262 for the lottery balls is shown first, then the chute 264 for the powerball is shown after the five lottery balls have been selected. The close-up view 270 may show real-life balls 268, or it may show computer-generated images of the balls 268. Further, the close-up view 270 may be a part of the real-life video 256, or it may be a separate video clip that is superimposed on top of the real-life video 256. Such a technique is well-known to those having ordinary skill in the art and therefore will not be described here. It will suffice to say that having the close-up view 270 as a separate video clip allows the same real-life video 256 to be played in the background and only the superimposed close-up view 270 needs to be different for each outcome.

To instill confidence in players that the drawing is truly random, the close-up view 270 should ideally be able to show all outcomes of the drawing. Where the close-up view 270 uses animation such as computer-generated balls, showing all outcomes may be accomplished by having the gaming terminal 10, or alternatively the game control network 40, generate the video images of the balls as needed. Where the close-up view 270 uses real-life balls, the task may be more difficult, though still within the ability of persons having ordinary skill in the art. For example, in the illustrated LOTTO BONUS format of thirty-one non-repeating numbered balls and seven non-repeating secondary balls, for the close-up view 270 to be able to show every possible outcome, a library of over 100 million different video clips would be needed (which includes the different orders the balls may be drawn in).

As a more practical alternative, it is possible instead to store close-up views of only a certain predetermined number of outcomes so long as the number is sufficiently large to give the appearance of randomness. The benefit to players in such an approach, of course, is that the odds of winning are much higher than they would be in a truly random lottery drawing.

Another more practical alternative is to show the real-life balls only while they are rolling into or through a portion of the chutes 262 and 264. Then, computer-generated images may be used for the balls in the close-up view 270 as they are supposed to appear in their respective positions in the chutes 262 and 264. In this way, it would only be necessary to have a real-life video clip of each ball as it is rolling down the chute path (or portion thereof) and into the chutes 262 and 264. Since there are thirty-one lottery balls and seven power balls, the total number of real-life video clips that would be needed is thirty-eight. And as alluded to above, these thirty-eight video clips may be separate from the real-life video 256, or they may be a part of the real-life video 256 so that there are 38 different versions of the real-life video 256.

The video clips that make up the real-life video 256 and the close-up view 270 may be stored using any suitable compression technology or standard. Examples of compression standards that may be used to store the video clips include any one of the MPEG standards (e.g., MPEG-1, MPEG-2, MPEG-4, MPEG-7, MPEG-21), H.261, H.263, DV, and DivX, all of which are well-known video compression standards and will therefore not be described here. The library of video clips may be stored locally to the gaming terminal 10 via the storage unit 32 (FIG. 2), or it may be stored remotely via the game control network 40, either in the network memory 42 or on a separate network storage unit (not expressly shown). If stored via the game control network 40, the real-life video 256 and the close-up view 270 may be streamed as data packets to the gaming terminal 10. Alternatively, where a single real-life video 256 is used, that video clip may be stored locally while the video clips that make up the close-up view 270 may be streamed as needed from the game control network 40 based on the outcome of the lottery drawing.

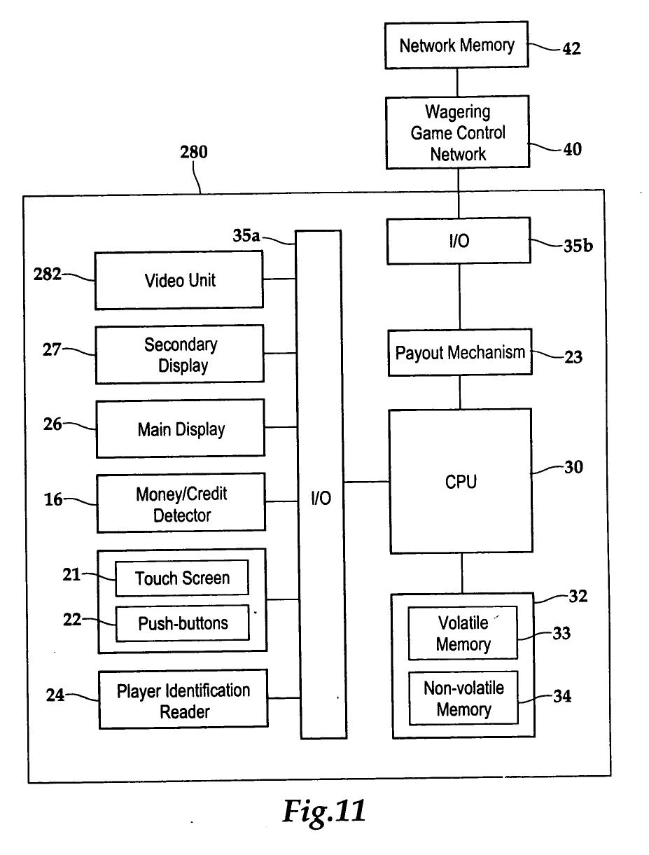

FIG. 10 shows the communal display 108 after a complete set of lottery balls, including the power ball, has been drawn. As can be seen, all the numbers for the drawn lottery balls are displayed, indicated generally at 272. FIG. 11 illustrates an exemplary gaming terminal 280 according to such an embodiment. As can be seen, the gaming terminal 280 is similar to the gaming terminal 10 of FIG. 2 in that it includes many of the same components and is also connectable to the wagering game control network 40. Unlike the earlier gaming terminal 10, however, the present gaming terminal 280 includes a separate, stand-alone video unit 282. Alternatively, the video unit 282 could be connected to the wagering game control network 40.

In operation, the video unit 282 is controllable by the CPU 30 to provide full screen, full-motion playback of the real-life video 256 and the close-up view 270 on the communal display 108. Because the video unit 282 is a separate, stand-alone unit, it is capable of processing and providing the full-screen, full-motion playback with little or no assistance from the CPU 30 or the other components in the gaming terminal 280. For example, the video unit 282 does not require the CPU 30 or the other components in the gaming terminal 280 to compress/uncompress the real-life video 256 or the close-up view 270, or to process or otherwise render the real-life video 256 or the close-up view 270. Any such compression/decompression (if needed) or rendering may be handled entirely, or almost entirely, by the video unit 282. The video unit 282, however, does need the CPU 30, or alternatively the gaming control network 40, to identify which video clips need to be played and when to play them.

In some embodiments, the video unit 282 may be implemented using a DVD player that is mounted in or otherwise connected to the gaming terminal 280. In that case, the video clips of the real-life video 256 and the close-up view 270 may be stored on a DVD. Different types of bonus games may then be played by simply swapping out the DVD. For more information regarding the use of a DVD player in a gaming terminal, see U.S. Provisional Application, Ser. No. 60/567,731, filed May 3, 2004, entitled “Method and Apparatus for Presenting Media in a Gaming Device,” by Alfred Thomas and James Poole, which is incorporated herein by reference in its entirety.

In other embodiments, the video unit 282 may be implemented using a digital video recorder that is mounted in or otherwise connected to the gaming terminal 280. In that case, the video clips of real-life video 256 and the close-up view 270 may be stored on a magnetic storage unit such as the hard drive of the digital video recorder. Examples of such digital video recorders include the “Series2” digital video recorder available from TiVO, Inc. of Alviso, Calif. Other types of stand alone video units may certainly be used without departing from the scope of the invention.

A prerecorded lottery drawing has both an audio and a video component. Both the audio and video on the recording may then be modified to provide a plurality of different outcomes for the LOTTO BONUS gaming event. In some embodiments, the video component may be modified to add or change a number on a selected ball. For example, if the wagering game control network 40 randomly selects the number “5” as one of the balls for the drawing, a “5” can be added to a blank ball in the prerecorded, staged drawing-or the “5” can replace the original number drawn in a prerecorded, real-life drawing. Thus, the wagering game control network 40 is able to automatically generate a series of random numbers for the LOTTO BONUS gaming event and insert them into a simulated drawing, giving the player the look, feel, and excitement of a live drawing, when, in fact, the outcome of the LOTTO BONUS gaming event (i.e., the progressive game) is determined by a processor (e.g., random number generator) within the gaming network 100.

In alternative embodiments of the present invention, various portions of the simulated drawing may be replaced with real-life features. For example, one or more real-life ball-dispensing device (e.g., drum, tumbler, ball blower, etc.) may be provided with the gaming network 100. Additionally or alternatively, real-life balls may be provided along with the gaming network 100. In some embodiments, real-life balls may be contained in and dispensed from the ball-dispensing device while simulated balls are illustrated on the communal display 108. In yet other embodiments, simulated balls may be contained in and dispensed from the simulated drums while real-life balls are ejected by the gaming network 100 for the players to view. Suffice it to say that in alternative embodiments of the present invention, both real-life and simulated devices may be utilized in combination to conduct the lottery drawing.

As described with respect to decision box s124 (FIG. 5), a progressive game may be triggered in a variety of ways. When a progressive game is triggered, the wagering game control network 40 determines the players on the gaming network 100 that are eligible to participate in the progressive game. In some embodiments, any player who plays the maximum number of paylines 84 in the basic game is eligible to be invited to play the progressive game. Alternatively, a player at a gaming terminal 10a-d may be randomly selected to play the progressive game. In other embodiments, a player wagering a particular threshold value of credits during the current gaming session is invited to play the progressive game. In still other embodiments, all of the players having an active gaming session on the tournament network 100 are invited to play the progressive game.

In other embodiments of the present invention, non-basic game players can be eligible to participate in the LOTTO BONUS gaming event. For example, the gaming terminal 10 (FIGS. 1-2) could allow a non-basic game player to purchase a randomly generated or player-selected numbered ticket for a chance to win a portion of the progressive bonus award. In these embodiments, the non-basic game player would deposit cash or credits at the gaming terminal 10 into the wager receptor 16, or alternatively, into a separate wager receptor (not shown) provided for non-basic game players. This deposit, along with a portion of the wagers from the basic game, are then used to fund the progressive game.

After depositing the credits, the non-basic game player is allowed to select a combination of numbers via the number selection screen 160 (FIG. 6) or may choose to have a set of numbers randomly selected for them. The selected numbers could then be provided to the non-basic game player, for example, via a ticket that could be printed by the gaming terminal 10 (or at a secondary printer). The non-basic game player's ticket could, for example, include information from the player's card that could be used to contact them if they win the progressive award. Alternatively, or additionally, the winning numbers could be posted in a casino, on a web page, placed in an ad, or displayed in any other fashion sufficient to provide notice of the winning numbers to players.

The above-described LOTTO BONUS gaming event has been illustrated where a player selects five standard numbers and a secondary number. However, it should be noted that any amount of numbers with or without one or more secondary or powerball number may be used. Additionally, in some embodiments, the progressive jackpot is divided into a plurality of jackpots. For example, the players participating in the LOTTO BONUS gaming event may be prompted to select a different amount of numbers, with those selecting less numbers playing for a lesser jackpot.

In some embodiments, players wagering the maximum credits in the basic wagering game are allowed to play for the largest jackpot and are able to pick the same amount of numbers as will be drawn. Alternatively, players who wager less or play less lines, may only be prompted to select a lesser amount of numbers. For example, in the LOTTO BONUS gaming event described in FIGS. 5-8, a player wagering the maximum number of credits may be prompted to select 5 numbers and a secondary number, while another player may only be prompted to select 4 numbers, and still another player may only be prompted to select 3 numbers. The player selecting only 3 numbers plays for a smaller jackpot than the player selecting 4 numbers, while the player selecting 4 numbers is playing for a smaller jackpot than the player who selected 5 numbers and the secondary number-who is playing for the main jackpot.

In embodiments where different players select one or more different amount of numbers, a single, simulated drawing may be used to generate the numbers for the different players. For example, the first three numbers selected in the simulated drawing may be used for the player selecting only 3 numbers. A fourth number may then be selected in the simulated drawing that-when combined with the first three numbers-forms the winning numbers for a player who selected 4 numbers. A fifth number and the secondary number would then be selected to form the winning combination of numbers for a player who selected 5 numbers and the secondary number.

According to some embodiments of the invention, special balls are provided that may be randomly selected by a processor. For example, a wild-card ball can be incorporated that matches an otherwise unmatched player-selected number. A multiplier ball could be included that would multiply any award to a player by the number provided on the multiplier ball. Additionally, a bonus ball could be included that would provide a bonus award to every player participating in the LOTTO BONUS gaming event.

As described above, according to some embodiments the LOTTO BONUS gaming event is a ticketless progressive game that may be included within a gaming network 100. The LOTTO BONUS gaming event accompanies a basic wagering game operable on the gaming terminals 10a-d within the gaming network 100. Though a slots game has been illustrated as the basic game that the LOTTO BONUS gaming event accompanies, it should be clear from the above that any basic wagering game may be used. For example, the LOTTO BONUS gaming event may accompany a blackjack wagering game, a poker wagering game, a roulette wagering game, a keno wagering game, etc.

While the present invention has been described with reference to one or more particular embodiments, those skilled in the art will recognize that many changes may be made thereto without departing from the spirit and scope of the present invention. Each of these embodiments and obvious variations thereof is contemplated as falling within the scope of the claimed invention, which is set forth in the following claims.

What is claimed is:

1. A method of conducting a progressive gaming event, comprising:
receiving a wager from a player to play a basic wagering game;
displaying the basic wagering game on a video display;
initiating the progressive gaming event;
selecting a plurality of players, playing the basic wagering game, to participate in the progressive gaming event;
displaying a plurality of player-selectable objects on the video display from which the plurality of players may select; and
presenting a simulated drawing to the plurality of selected players, the simulated drawing displaying a combination of winning objects to the plurality of players on a communal display, wherein the plurality of winning objects are randomly generated.

2. The method of claim 1 further comprising:
determining the number of matching objects by comparing the player-selected objects to the combination of winning objects; and
presenting an award to one or more of the plurality of players when the number of matching objects meets a predetermine criterion.

3. The method of claim 2, wherein the acts of determining the number of matching objects and presenting an award are achieved without providing a ticket to any of the plurality of players.

4. The method of claim 2, wherein the acts of determining the number of matching objects and presenting an award are achieved without generating a ticket.

5. The method of claim 1, wherein the plurality of player-selectable objects are displayed to a player after the player has completed the basic wagering game.

6. The method of claim 1, wherein the basic wagering game is interrupted by displaying the plurality of player-selectable objects, the player being allowed to complete the basic wagering game after the progressive gaming event has been completed.

7. A method of conducting a lottery gaming event, comprising:
initiating the lottery gaming event on a gaming network when the lottery gaming event has been triggered;
selecting a plurality of players on the gaming network to participate in the lottery gaming event, the plurality of players being located at a plurality of gaming terminals within the gaming network;
displaying a plurality of user-selectable numbered objects on a video display on the gaming terminal of each of the selected plurality of players, each of the plurality of players being capable of selecting a plurality of objects from the user-selectable numbered objects; and
presenting a simulated drawing to the plurality of selected players, the simulated drawing displaying a combination of winning numbered objects to the plurality of players on a communal display included with the gaming network, wherein the plurality of winning numbered objects are randomly generated by the gaming network.

8. The method of claim 7, wherein the numbered objects are numbered lottery balls.

9. The method of claim 8, wherein the simulated drawing is a prerecorded lottery drawing having both a video and an audio component.

10. The method of claim 9, wherein the video component is modified based on the randomly generated winning numbered balls.

11. The method of claim 9, wherein the audio component is modified based on the randomly generated winning numbered balls.

12. The method of claim 7, wherein the displayed plurality of player-selectable numbered objects includes a plurality of secondary objects and the combination of winning numbered objects includes a winning secondary object.

13. The method of claim 8, wherein the winning combination of numbered balls includes a wild-card ball.

14. The method of claim 8, wherein the winning combination of numbered balls includes a multiplier ball.

15. The method of claim 8, wherein the winning combination of numbered balls includes a bonus ball.

16. The method of claim 7, wherein the selected plurality of players include non-basic game players that have deposited cash or credits into at least one of the plurality of gaming terminals located on the gaming network.

17. The method of claim 16, wherein the non-basic game players are provided a ticket that includes the selected numbers after a predetermined amount of numerical selections have been made.

18. A progressive gaming network, comprising
a plurality of linked gaming terminals, each gaming terminal for playing a basic wagering game allowing a player to be eligible for a progressive game, in response to the progressive game being triggered, each of the players at the plurality of gaming terminals selecting a group of objects from a plurality of objects; and
at least one communal display in proximity to the plurality of gaming terminals, the communal display displaying the randomly selected winning group of objects from the plurality of objects;
wherein a player is awarded one or more jackpot in the progressive game based on the amount of matching objects between the randomly selected winning group of objects and the group of objects selected by the player.

19. The progressive gaming network of claim 18 further comprising at least one jackpot display for displaying the value of the one or more jackpot for the progressive game.

20. The progressive gaming network of claim 18, wherein the progressive game is a lottery based gaming event.

21. The progressive gaming network of claim 20, wherein the plurality of objects are numbers.

22. The progressive gaming network of claim 21, wherein the plurality of numbers are located on a plurality of balls.

23. The progressive gaming network of claim 18, wherein the randomly selected winning group of objects are displayed as a simulated lottery drawing.

24. The progressive gaming network of claim 23, wherein the simulated drawing is a prerecorded drawing and the randomly generated selected winning group of objects are displayed therein.

25. The progressive gaming network of claim 18, the at least one communal display being located above the plurality of linked gaming terminals.
